(19) United States
(12) Patent Application Publication
(10) Pub. No.: US 2003/0126590 A1
(43) Pub. Date: Jul. 3, 2003

(54) System and method for dynamic data-type checking

(76) Inventors: Michael Burrows, Palo Alto, CA (US); Stephen Neil Freund, Menlo Park, CA (US)

Correspondence Address: Pennie & Edmonds, LLP, 3300 Hillview Avenue, Palo Alto, CA, 94304, US

(21) Appl. No.: 10/040,774

(22) Filed: Dec. 28, 2001

(51) Int. Cl. G06F 9/45

(52) U.S. Cl. 717/154

(57) ABSTRACT

A data-type checker dynamically verifies program operation. The data-type checker, while executing a specified computer program, maintains a shadow array that has entries corresponding to respective memory locations used by the specified computer program. Each entry of the shadow array indicates a data type of the corresponding respective memory location. While executing the specified computer program, the data-type checker executes each of a set of instructions of the computer program. For the execution of each instruction in a subset of the set of instructions of the computer program, the data-type checker determines whether execution of the instruction is inconsistent with an entry of the shadow array and, if so, generates a report. The data-type checker then executes the instruction, and updates the shadow array in accordance with execution of the instruction.

The present invention relates generally to checking memory validity, and more specifically to dynamically determining memory errors through data-type checking.

### BACKGROUND OF THE INVENTION

Memory errors occur when a program attempts to access portions of memory for which access is not allowed, or is not appropriate. These types of errors can be fatal and cause application or system crashes because of the likelihood of system corruption, either from writing to portions of memory that store critical values, or reading out values from memory that are critically different than the expected data.

One type of a memory error is an “out of bounds” error. For example, if an application allocates a memory block of twenty-four bytes for an array, and then reads the memory location twenty-five bytes from the first byte, this would result in an out of bounds error. Another type of a memory error is an “uninitialized” error. In this case, an application allocates a memory block, but does not set any of the allocated memory to a value before attempting to read from it. An additional type of memory error is an “invalid pointer” error in which, for example, a pointer that points to a particular memory location (e.g., an object at that memory location) is dereferenced, after the particular memory location has been deallocated. Another type of memory error is an “improper data type” error, when, for example, an “integer” value is written into a variable that has been declared to be of a “character” data type. Yet another type of a memory error is an “improper combination” error, in which two variables or values having inconsistent data types are summed or combined, and then stored in memory. It is highly desirable to avoid these types of memory errors.

One way to reduce memory errors is to keep track of whether a memory location is allocated and/or initialized. In most computing languages, memory space must be allocated by a program in order for the program to be able to reserve and to use the memory space. After memory space has been allocated, it then can be initialized by writing a value to it. Thus, there are three possible states for memory locations: unallocated, allocated and uninitialized, and allocated and initialized. Checking the state of a memory location before conducting a read or write operation will reduce the number of memory errors that may occur, because unallocated and uninitialized errors can be determined in advance of a memory access, decreasing the probability of performing a memory operation at an undesired location. However, there is currently no method to detect, for example, an out of bounds memory access if the location being written to or read from is, coincidentally, properly allocated and initialized.

There are two places to store information about the allocation and initialization state of a memory location—in the memory location itself, or in a memory status array. Storing the current memory allocation and initialization state, out of the three possible states described above, requires only two bits, and can either be appended to the particular data at a memory location, or can be stored in a “memory status array” or “shadow array” that corresponds to the actual memory locations. One example of the use of a memory status array to record the current allocation and initialization state is disclosed in U.S. Pat. No. 5,335,344 (the “'344 patent”). The '344 patent discloses a two-bit memory status array that stores the current allocation and initialization state for each memory location. The '344 patent teaches adding, before each preexisting instruction in an application that accesses memory or that can change memory status, extra instructions to maintain a memory status array. It further teaches using the memory status array to check for errors in writing to unallocated memory, and in reading from uninitialized or unallocated memory. However, as discussed previously, checking the allocation and initialization state of a memory location is an unreliable method for determining whether a memory access is occurring out of bounds, nor will it detect data-type inconsistencies in executing instructions, or in storing values into variables.

Another way to check for memory errors is to make instructions in a program data-type specific. Most computer programming languages have a limited number of data types, each of which has an associated set of predefined characteristics, such as the range of legal values for each given data type, how data values of that data type are processed by the computer, and how data value of the data type are stored in memory. Examples of data types are: integer (e.g. short integer (16-bit) and long integer (32-bit)), character, string, floating point number, byte, and pointer.

An example of data-type specific instructions are the bytecode instructions of Java. The Java® Virtual Machine (JVM) (Java and JVM are trademarks of Sun Microsystems, Inc.) includes a program verifier for ensuring that a Java bytecode program utilizes data in a manner consistent with the data-type specific instructions of the Java instruction set, which helps to ensure that the program will not violate the integrity of a user's computer system. The JVM program verifier, which checks a program in advance of actually executing the program, steps through the program's bytecode instructions to ensure they are correctly data-type matched to each other, and to the values put on the stack and into registers. This type of static data-type checking cannot analyze the data types of dynamic values put into memory (other than the stack and registers) during execution of a program, however, because it can only determine data types of the instructions themselves, and of the explicit declared structure of variables recited in the instructions. Furthermore, many other computer programming languages do not use data-type specific instructions, or include many instructions that are not data-type specific, making it impossible to statically check the memory integrity of computer programs in these other languages.

Therefore, it would be desirable to provide a system and method for dynamically verifying program operation by dynamically checking the integrity of the data types of memory locations accessed during execution of a program.

### SUMMARY OF THE INVENTION

In one embodiment of the present invention, a dynamic data-type checker creates shadow arrays for the heap, stack, and registers. It verifies that, during execution of a program, accesses to locations in memory are consistent with the data types stored in the shadow array corresponding to the memory locations. If the data types associated with the access of a location in memory, and the location itself, are inconsistent, the data-type checker makes a record of the error, executes the instruction, and then updates the shadow array with the data type of the memory location after execution.

Another aspect of the present invention is a method for dynamically verifying program operation. The method, while executing a specified computer program, maintains a shadow array that has entries corresponding to respective memory locations used by the specified computer program. Each entry of the shadow array indicates a data type of the corresponding respective memory location. During execution the specified computer program, the method executes each of a plurality of instructions of the computer program, and for each instruction in a subset of the plurality of instructions, determines whether execution of the instruction is inconsistent with an entry of the shadow array. If so, the method generates a report. Finally, the method executes the instruction, and updates the shadow array in accordance with execution of the instruction.

In one embodiment, the dynamic data-type checker of the present invention conducts its data-type checking by interpreting the pre-existing instructions of a program. In another embodiment, the data-type checker conducts its data-type checking by reverse-compiling pre-existing object code to an intermediate state, and then instrumenting the program with new dynamic checking instructions that check the data types of memory and of the original instructions.

### BRIEF DESCRIPTION OF THE DRAWINGS

Additional objects and features of the invention will be more readily apparent from the following detailed description and appended claims when taken in conjunction with the drawings, in which:

FIG. 1A is a logical block diagram of a general computer system that may practice the present invention, and in particular, shows an embodiment of the present invention that uses a program interpreter.

FIG. 1B is a logical block diagram of a general computer system that may practice the present invention, and in particular, shows an embodiment of the present invention that uses a program instrumenter.

FIG. 2A is a block diagram of the registers, stack, and heap, and their corresponding shadow arrays.

FIGS. 2B and 2C are examples of data-type fields in accordance with one embodiment of the present invention.

FIG. 3 is a functional block diagram demonstrating the process of compiling a program to obtain debugging information in one embodiment of the present invention.

FIG. 4 is a functional block diagram of the process of compiling and instrumenting a source code program in accordance with one embodiment of the present invention.

FIG. 5 is functional block diagram of the process of executing and interpreting a program in accordance with another embodiment of the present invention.

FIG. 6A is a functional block diagram of an illustrative source code program compiled into a compiled code program that demonstrates one example of the operation of the present invention.

FIG. 6B is a representation of the structure of an array that is established by the program in FIG. 6A.

FIG. 7 is a representation of the array structure of FIG. 6B that is stored on the stack, and of a corresponding shadow array that stores the data types for corresponding locations on the stock.

### DESCRIPTION OF THE PREFERRED EMBODIMENTS

Generally, the dynamic data-type checker of the present invention presents a novel way to check memory validity and integrity against the requirements of computer program instructions. The data-type checker sets up shadow arrays for all locations of memory—e.g., the registers, stack, and heap. Each location in the shadow arrays corresponds to a location in memory and stores the data type corresponding to that memory location. The data types of memory locations can be established by variable and structure declarations in the program, associated with the location through the data type of a value stored there, or exclusively limited to one data type by definition.

One important aspect of the data-type checker of the present invention is that it performs data-type checking on the instructions of a program without requiring any modification of the original instructions. Instead, the data-type checker performs data-type checking either through instrumenting the original program, or by interpreting the instructions as they are executed. Thus, in one embodiment, the data-type checker partially reverse-compiles the object code of the program to be checked back to an intermediate representation or format. The data-type checker then instruments dynamic checking instructions into the original program, and the modified program, including both the original instructions and the instrumented dynamic checking instructions, is subsequently recompiled into object code by the original, unmodified compiler. In another embodiment, the data-type checker of the present invention utilizes an interpreter to perform dynamic data checking on instructions of the original program as they execute, without having to modify the original program. In either case, the data-type checker may use debugging information provided by the compiler to identify locations in memory and the data type of the data stored there, and to initialize a corresponding shadow array.

In operation, the dynamic data-type checker of the present invention, in various embodiments, whether utilizing instrumented dynamic checking instructions or utilizing an interpreter, obtains the next instruction to execute, and identifies memory locations that will be affected by that instruction. It examines locations in the shadow array corresponding to the identified affected memory locations, and checks the data type of those shadow array locations. If a data type in the shadow array is inconsistent with the data-type requirements of the instruction to be executed, the data-type checker generates a report of this inconsistency or error. The data-type checker then executes the instruction and updates the shadow array in accordance with the results of the executed instruction.

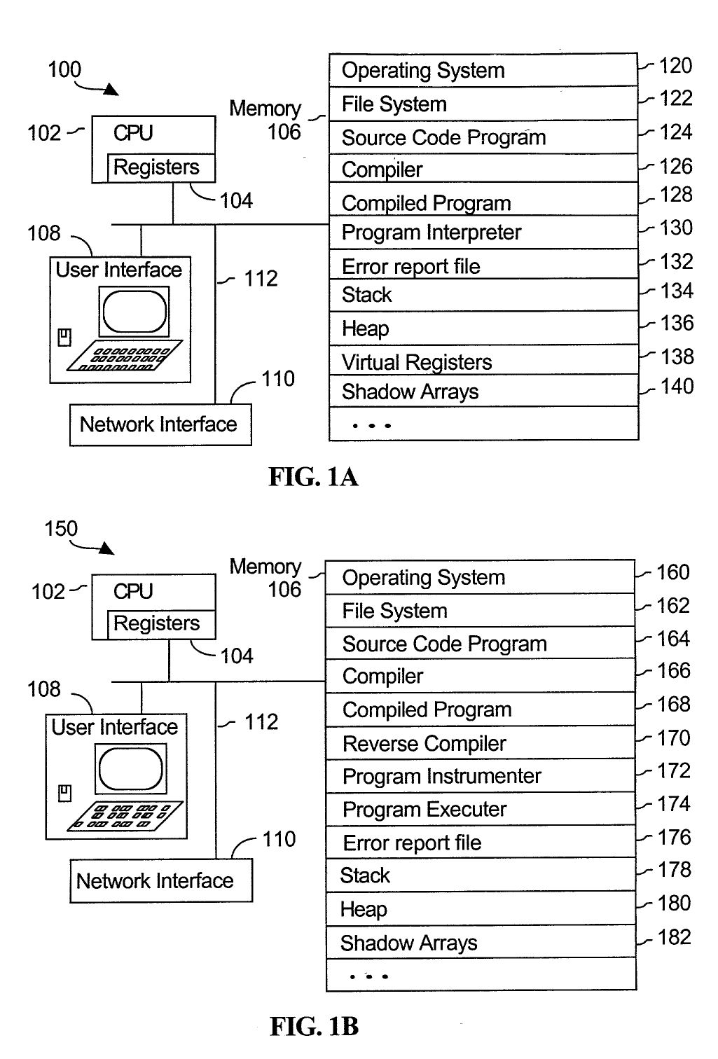

Referring to FIG. 1A, a computer system 100 capable of practicing the present invention is shown. The computer system 100 includes one or more central processing units (CPU) 102 (which contain registers 104), memory 106 (including high speed random access memory, and non-volatile memory such as disk storage), an optional user interface 108, and a network interface or other communications interface 110 for connecting the computer system 100 to servers and/or client devices through a network interconnection. These components are interconnected by one or more system busses 112. The memory 106 typically stores an operating system 120, file system 122, source code program 124, compiler 126, compiled program 128, program interpreter 130, error report file 132, stack 134, heap 136, virtual registers 138, and shadow arrays 140. The memory 106 may also store further modules and data structures not shown, and is not meant to be limited to only the features identified in the figure. The embodiment of the present invention shown in FIG. 1A uses program interpreter 130 to dynamically conduct data-type checking of the source code program 124.

Referring to FIG. 1B, another computer system capable of practicing the present invention is shown. In this embodiment, computer system 150 has the same hardware components as the computer system 100 shown in FIG. 1A, but in other embodiments, may have more or less components. The memory 106 typically stores an operating system 160, file system 162, source code program 164, compiler 166, compiled program 168, reverse compiler 170, program instrumenter 172, program executer 174, error report file 176, stack 178, heap 180, and shadow arrays 182. Again, the memory may have other modules not shown. The embodiment of the present invention shown in FIG. 1B uses program instrumenter 172 to add dynamic checking instructions to the original source code program 164 to dynamically conduct data-type checking.

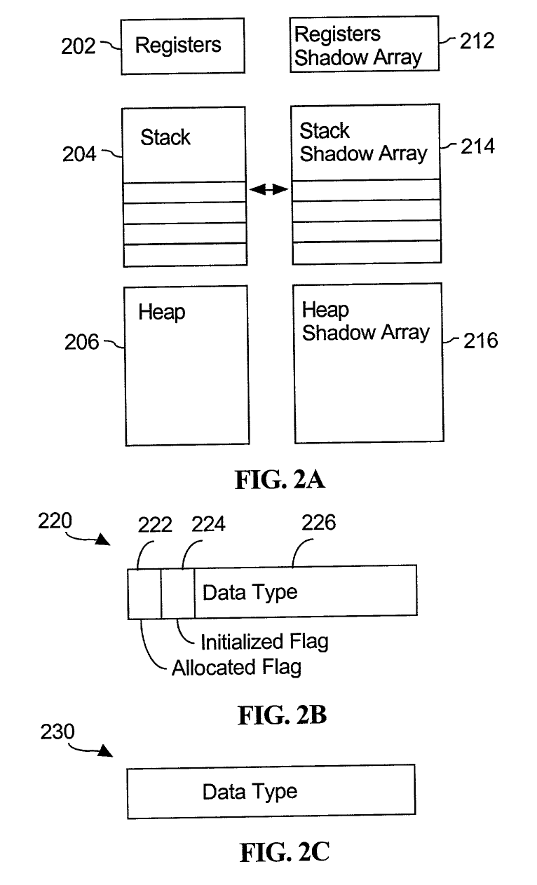

Turning to FIGS. 2A, 2B, 2C, examples of different types of memory and shadow arrays are shown. Specifically, a computer may have registers 202, stack 204, and heap 206. Generally, registers are special types of memory located directly in the microprocessor that provide a place for passing data from one instruction to the next sequential instruction, or to another program that the operating system has given control to. The stack is a programming tool representing a data area or buffer used to store information being passed between programs, to store information needed by programs when their execution resumes, and to temporarily store information for an executing program. The information stored in the stack includes local variables and data related to function and procedure calls. Typically, a stack is implemented as a push-down list, meaning that as new requests come in, they push down the old ones. When instructed to do so, a program “pops off” items from the stack by reading one or more memory locations, starting at a location identified by a stack pointer, and then resetting the stack pointer to point to a location corresponding to the topmost item remaining on the stack. Finally, the heap is an area of computer memory from which a program can allocate (i.e., reserve) room to dynamically store objects and other data. The heap enables programs to allocate memory on an “as needed” basis, to store data while the program is running. The location of the stack and heap within a computer system's memory 106 may vary from time to time and from one implementation of the present invention to another.

The registers 202, stack 204, and heap 206 correspond to registers shadow array 212, stack shadow array 214, and heap shadow array 216, respectively. The shadow arrays store data-type information for locations in the registers, stack, and heap. An example of a data-type field 220 is shown in FIG. 2B. In this embodiment, the data-type field 220 has an allocated flag 222, an initialized flag 224, and a data-type entry 226. The allocated flag 222 indicates whether the corresponding memory location is allocated or unallocated, and is typically one bit. The initialized flag 224 indicates whether the corresponding memory location is initialized or uninitialized, and also is typically one bit. The data-type entry 226 indicates the data type of the data stored (or to be stored) in the corresponding memory location. To represent all of the possible data types, this field utilizes a number of bits equal to log base two of the total number of possible data types, log₂(number of possible data types).

Another embodiment of a data-type field 230 is shown in FIG. 2C. In this data-type entry, there are not separate flag fields for the allocated and initialized bits; instead, they comprise part of the data field entry itself. In this embodiment, a data-type field might be “allocated uninitialized integer,” or “allocated initialized pointer.” Because, as discussed above, there are two principal states of allocated fields (uninitialized and initialized), the number of possible data types in this embodiment can be expected to be about twice as many as the number of data types of the data-type entry 226 in data-type field 220. (The exact number of possible data types in each representation depends, in part, on how the data type of unallocated memory locations is represented.) Like with data-type entry 226, data-type field 230 utilizes a number of bits equal to log base two of the total number of possible data types.

In one embodiment of the present invention, allocation and initialization information is not maintained for the stack shadow array 214. This is because all data currently “on” the stack (as opposed to being “popped off” the stack) is determined by the position of the stack pointer; therefore, separate memory allocation tracking may be unnecessary for memory locations within the stack.

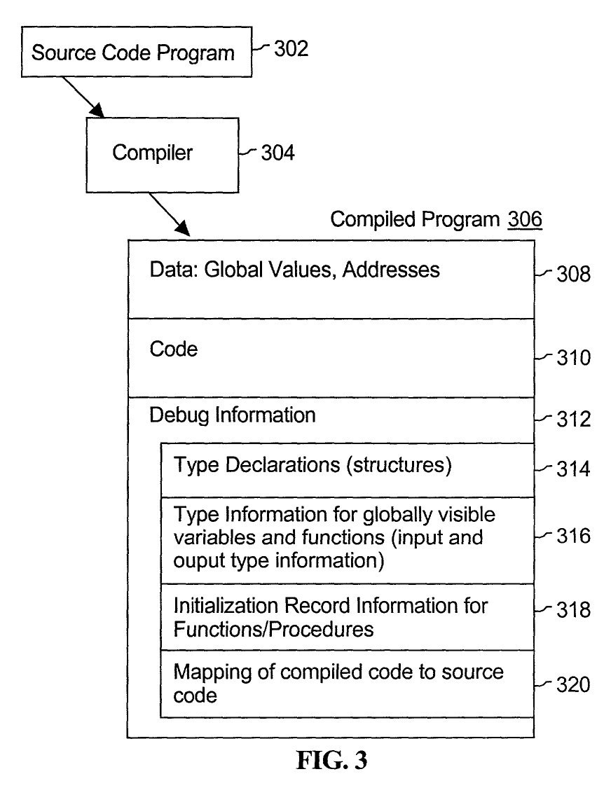

Referring to FIG. 3, an example of a compiled program is shown. To obtain compiled program 306, a source code program 302 is analyzed and processed by a compiler 304. The resultant compiled program 306 has three main features that are relevant to the present discussion. First, the compiled program includes a data output 308, which includes the global values used in the program, as well as the addresses of the variables used in the program, such as register addresses. Next, the compiled program includes the compiled code 310 itself, which has been compiled by the compiler 304 into object code that can be used by, for example, program executer 174 or program interpreter 130 to execute the program. Finally, the compiled program has debug information 312.

Debug information 312 can have at least four different categories of information. In one embodiment, debug information 312 includes type declarations 314, which typically include the size, name, and elements of the variables and other data structures in the program, and commonly is established by structure declarations in the source code program 302. Debug information 312 may also include type information for globally-visible variables and functions 316. Type information 316 identifies input and output type information for function and procedure calls, such as the parameters passed to functions. Debug information 312 further may include initialization record information for functions and procedures 318. The initialization record information is established each time a function or procedure is called, and includes the register and stack information, including local variables, for the function or procedure. Finally, debug information 312 may include mapping of the compiled code to the source code information 320. In other embodiments, debug information 312 may contain less than these four illustrative categories of information, or may contain additional categories of information, as will be appreciated by those of skill in the art.

The dynamic data-type checker uses the debug information 312 in two principal ways, for some embodiments of the present invention. First, the data-type checker uses the debug information to initialize and populate portions of the registers shadow array 212, stack shadow array 214, and heap shadow array 216. Second, the data-type checker uses the debug information 312 to determine data-type inconsistencies between instructions making memory accesses, and the memory locations the instructions are accessing.

To initialize and populate portions of the shadow arrays, the data-type checker obtains data-type information for variables and memory locations from certain categories of the debug information 312. For example, the data types for global variables are available at program startup from the debug information—in particular, from type declarations 314, and from type information for globally visible variables and functions 316. Also, the data-type checker can determine the location in memory of the global variables from the type information 316. The program may map the location of the global variables to the heap, or possibly to a register (or virtual register) if enough registers are available, and immediate access to the global variable is deemed by the compiler to be important. Thus, at program startup, the data-type checker determines where a global variable “lives,” and then initializes the corresponding shadow array with the data type of each global variable.

The data-type checker also initializes the portions of the shadow arrays corresponding to local variables from the debug information 312. Local variables are typically pushed onto the stack when a function or procedure is called, as part of the “activation record” for the function. An activation record stores local variables for a function call, and may store a pointer to the last activation record on the stack, as well as the return address of the program that has called the function being executed. The initialization of an activation record also establishes the size and location of that activation record on the stack, which is important because it allows the data-type checker to establish an equivalent-size entry in the stack shadow array 214 at the corresponding locations. This size, as well as the data types of the local variables for the stack shadow array, is available from the initialization record information 318 of the debug information. Also, in addition to being stored on the stack, local or temporary variables can also be stored in a register or virtual register. The mapping of a local or temporary variable to a register or virtual register, as well as the data type of that variable, is also available from initialization record information 318.

Further, the data-type checker initializes and populates other portions of the registers shadow array 212, and the heap shadow array 216, without respect to a particular global or local variable. This occurs when registers 202, or memory in the heap 206, are allocated for a certain type of data. The data type of the memory allocated in the registers and the heap, as well as the particular locations allocated, are available from the type declarations 314, and the type information for globally visible variables and functions 316. (Memory in the heap and registers can also be data-typed when data is written into a particular memory location, which is then assigned that data type, but this information is obtained dynamically during program execution, and not from the debug information 312).

As stated above, the second principle use of the debug information 312 is determining data-type inconsistencies between instructions making memory accesses, and the memory locations the instructions are accessing. In order to identify data-type inconsistencies, the data-type checker determines both the data type, or the data-type requirements, of each instruction upon execution, as well as the data type for each location in memory being accessed at the time of execution of the accessing instruction.

In determining the data type of the instructions, the data-type checker generally confronts two types of instructions—those that utilize a variable or variables, and those that do not. Because the data type of all variables are established by type declarations in the program, and recorded in the type declarations information 314 of the debug information 312, determining the data-type requirements of an instruction containing a variable is generally straightforward. However, for an instruction not containing a variable, such as an instruction that writes a direct value into memory, data-type determination is more difficult. The dynamic data-type checker of the present invention can generally determine what data type the instruction is, or what data type the instruction affects upon execution, based upon the context of the instruction. This information likely would not be available from the debug information 312.

In one embodiment of the present invention, when the data type of a memory access instruction cannot be determined, the data-type checker assigns a unique data type to that particular kind of memory access instruction, for example, “type A.” As multiple unique data types are assigned, observations concerning the relationships among the unique data types can be made. For example, if another memory access instruction, assigned the unique data type “type B,” accesses the same memory location as the memory access instruction assigned “type A,” then the data-type checker determines a “type equivalence” between these two data types. Thereafter, memory accesses to the same memory location by either kind of instruction would not result in an error. In other cases, however, where “type A” and “type B” data types are not equivalent to one another, but “type A” is equivalent to a significant number of one particular type, and “type B” is equivalent to a significant number of a different type, this suggests a “type non-equivalence.” In this case, if a memory access instruction assigned as “type A” attempts to access the same memory location that has been accessed by a memory access instruction assigned as “type B,” the data-type checker assumes a memory inconsistency error, and reports such.

In addition to determining the data type of the instructions, the data-type checker must also determine the data types of memory locations. As discussed above, the data-type checker can initialize and populate portions of the shadow arrays by using the debug information 312. There is an important distinction, however, between the data type of a memory location storing a variable or data, and the data type of the variable or the data stored there. While memory locations may have a corresponding data type, in some situations (described below) this data type is not automatically the data type of the variable or data stored in that memory location. In general, data types of memory locations are assigned by giving memory locations a particular data type at allocation, by assigning memory locations the data type of the data that is written into the location when it is initialized, by assigning memory locations the data type of the data that is written into the location after initialization, or any combination of these.

If a memory location is not assigned a particular data type at allocation, and no data has been written into that memory location, the data type for that location will be unknown. In one embodiment, when the shadow arrays are initialized, the data-type checker assigns memory locations that do not have an identifiable data type the data type “unknown,” in the corresponding shadow array.

Once the data-type checker determines data type of a memory location, it writes that data type to a location in a shadow array corresponding to the memory location. The data type may be specific or unknown, and may be determined during startup of a program, during creation of an initialization record for a function or procedure call, or during the writing of data into a memory location. Thus, for example, if the data-type checker determined that location 001 of the heap 206 is an integer, it would write the data type “int” (for integer) to location 001 of the heap shadow array 216. In one embodiment, each of the registers shadow array 212, stack shadow array 214, and heap shadow array 216 is identical in length to the respective registers 202, stack 204, and heap 206, and corresponds to the same memory locations. If the shadow arrays are located in a separate, redundant memory from the main memory, the shadow arrays may be implemented using the same addressing scheme as the main memory, reducing the need for mapping information. Alternatively, the shadow array entries may include data that indicates what location in memory each entry corresponds to, or a distinct look-up table may map each shadow array entry to a location in memory. It will be appreciated that any mapping scheme within the knowledge of those of skill in the art is intended to be within the scope of the invention.

When the data-type checker determines a data-type inconsistency between an instruction making a memory access, and the memory location being accessed, the data-type checker generates a report of the error. As part of the information disclosed about the error, in one embodiment, the data-type checker presents the line in the source code program 302 where the memory inconsistency error occurred. This is also determined from the debug information 312, and in particular from the mapping of compiled code to source code information 320.

As described herein, there are at least two methods to implement the functionality of the present invention without requiring the development of any additional source code by the original application developer. One method, consistent with FIG. 1A, is to use a program interpreter 130 to make data-type determinations, and to make comparisons between the data types of each instruction of the source code program affecting memory, and the memory location being affected. Another method, consistent with FIG. 1B, is to use a reverse compiler 170 and a program instrumenter 172 to add additional dynamic checking instructions to the program to make these determinations and comparisons. In yet another embodiment, the source code program may be initially compiled by a compiler so as to generate an intermediate representation of the program (preferably including the debug information shown in FIG. 3), the intermediate representation of the program is instrumented with dynamic data-type checking instructions, and then the resulting modified intermediate representation of the program is further compiled into executable code. Further, any other system, computer program product or method that implements the functionality of the present invention without requiring modifications to the original source code is also be within the scope of the present invention.

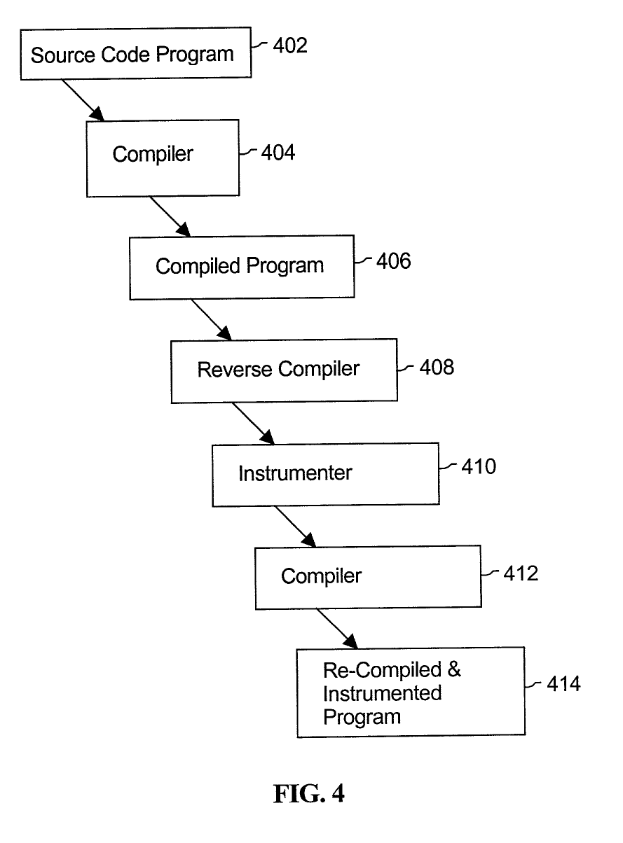

Referring to FIG. 4, an embodiment of the present invention that uses a program instrumenter is shown. In this embodiment, a source code program 402 is compiled by compiler 404, resulting in compiled program 406. Compiler 404 performs the normal steps for compiling a source code program in order to create executable object code. Then, the object code is reverse-compiled by reverse-compiler 408. The reverse-compiler 408 does not reverse-compile the compiled program 406 back to the source code program 402. This is because, while the instrumenter 410 does not add instructions to the compiled program 406 directly, it also does not modify the original source code program, either. Instead, the reverse-compiler 408 reverse-compiles the compiled program 406 back to an intermediate representation or format. The intermediate representation preferably includes a symbol table, and/or other table-type data structure as known by those of skill in the art. The intermediate representation may also include a graph representation, such as a control-flow graph, of the program's partially compiled instructions. The intermediate representation of the program, much like the debug information 312, provides the instruction line numbers, conditional jump and loop target destinations, offsets, structures of the variables, variable values, and other aspects of source code program 402 sufficient for instrumenter 410 to determine where to insert dynamic checking instructions, and what type of dynamic checking instructions to insert.

The dynamic checking instructions inserted by the instrumenter 410 will, during execution of the program, dynamically determine data types of memory locations of the stack, heap, and registers. These dynamic checking instructions will also make comparisons to determine if there are data-type inconsistencies. The comparisons include comparisons of the data types of instructions and the data types of memory locations, and comparisons of the data types of two or more items of data that are being combined. These comparisons make use of the data type information stored in the shadow arrays. This type of dynamic data-type checking is particularly advantageous over static data-type checking because the data type of many instructions and memory locations cannot be determined until a program is actually executing. After the dynamic checking instructions have been added by the instrumenter 410, compiler 412 re-compiles the now instrumented program, which is based on both the original source code program 402 instructions, as well as the newly-inserted dynamic checking instructions. In one embodiment, the compiler 412 is a standard compiler for compiling programs written in the programming language of the source code program 402, and may be the same compiler as compiler 404. However, unlike compiler 404, compiler 412 does not require procedures for converting source code into the intermediate representation, and therefore compiler 412 may be a distinct compiler from compiler 404. In either case, the result of the compilation is the re-compiled and instrumented program 414, which can be executed as normal object code.

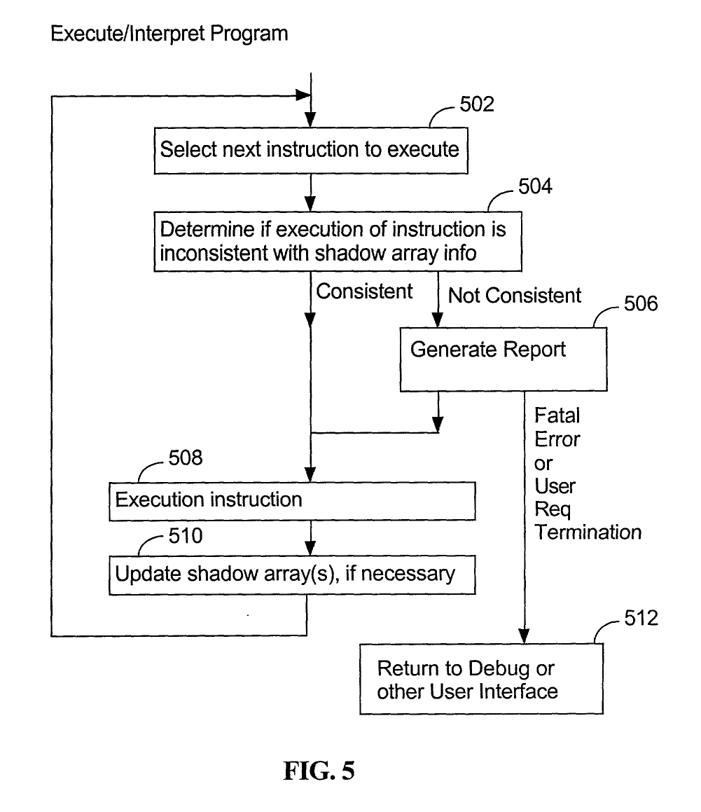

Referring to FIG. 5, another embodiment of the present invention that uses a program interpreter is shown. In this embodiment, no special modifications are made to the compiled program—instead, a program interpreter that interprets (and correspondingly executes) the program is designed to implement the functionality of the present invention. (The dynamic checking instructions of the instrumented version of the present dynamic data-type checker can also accomplish the functionality shown in FIG. 5.) In the course of executing a source code program, the interpreter selects a next instruction to execute (502). The address of the next instruction is either determined from the current instruction itself (if the instruction involves a jump, conditional jump, or a conditional loop), or is obtained by determining the location of the next sequential instruction. The interpreter then determines if execution of the instruction is inconsistent with the shadow array information (504). The shadow arrays are initialized and populated in accordance with the procedures described above.

The interpreter determines an inconsistency between an instruction, and the memory location affected by that instruction, when the associated data types are different, e.g. “int” versus “pointer,” or are a different class. If the interpreter determines that execution of the instruction is inconsistent with the shadow array information, it generates a report (506) of the error. In one embodiment, the report will contain the line number of the source code where the error occurred, obtained from the mapping portion 320 of the debug information 312, together with the data types of the instruction, or variables used by the instruction, and the memory location accessed by the instruction. The error report may be a running log file.

In one embodiment, an error may also generate an interrupt message, which then causes the interpreter to inform the user of the data-type mismatch error, and to query the user whether he or she wishes to return to a debug or other user interface (512). In another embodiment, the interpreter simply returns directly to a debugging program or other user interface directly, without querying the user. Also, certain types of memory errors, such as those that affect the kernel or other system-crucial memory data, will cause a fatal error that causes the current process to fail. If this happens, in one embodiment, the interpreter also returns to a debug or other user interface (512).

If the interpreter determines that execution of the instruction is consistent with the shadow array information, or if the interpreter determines that it is inconsistent, but the error is not fatal, or the user does not require termination of the program, the interpreter executes the instruction (508). Then, the interpreter updates the appropriate shadow array, if necessary (510). If a memory access does not affect the data type of the memory location being accessed, there is no requirement that the interpreter update anything in the shadow array. This is true if, for example, the instruction merely requests a read from a memory location, or if it writes a value to a memory location that has the same data type as the current data type of the memory location.

If, on the other hand, the instruction causes a value with a new data type to be assigned to a memory location, the interpreter can either update the shadow array with the new data type, or disregard it. In some cases, the context of the instruction may specify what the interpreter should do—for example, deallocated memory which is reallocated and assigned a different data type should clearly have its corresponding shadow array entry updated. In another example, when a value having a new data type is written to a register, the corresponding shadow array entry should be updated (because registers are often dynamically allocated).

In some cases, however, it may be less clear whether the shadow array should be updated. In these situations, in one embodiment, the interpreter updates the corresponding shadow array entry with the new data type regardless of a data-type inconsistency. In some versions of this embodiment, the interpreter may always update the shadow array, even if it means merely rewriting the exact same data type that is currently stored in the shadow array. In another embodiment, the interpreter does not update the corresponding location with the new data type, but instead disregards it. This reflects the fact, discussed previously, that the data type of a memory location and the data stored in the memory location are not automatically the same. This embodiment may be useful when memory and variable structure integrity is particularly important from the beginning of program execution. In any event, with the exception of a fatal error or a user-requested termination of the program, the program continues executing.

One important aspect of the present invention, and in particular the embodiment of the present invention shown in FIG. 5, is that the order of the steps is not fixed. The interpreter may both select (502) and execute (508) the next instruction before determining data-type inconsistencies (504), or it may both determine if execution of the instruction is inconsistent with the shadow array information (504), and update the shadow array if necessary (510), before executing the instruction.

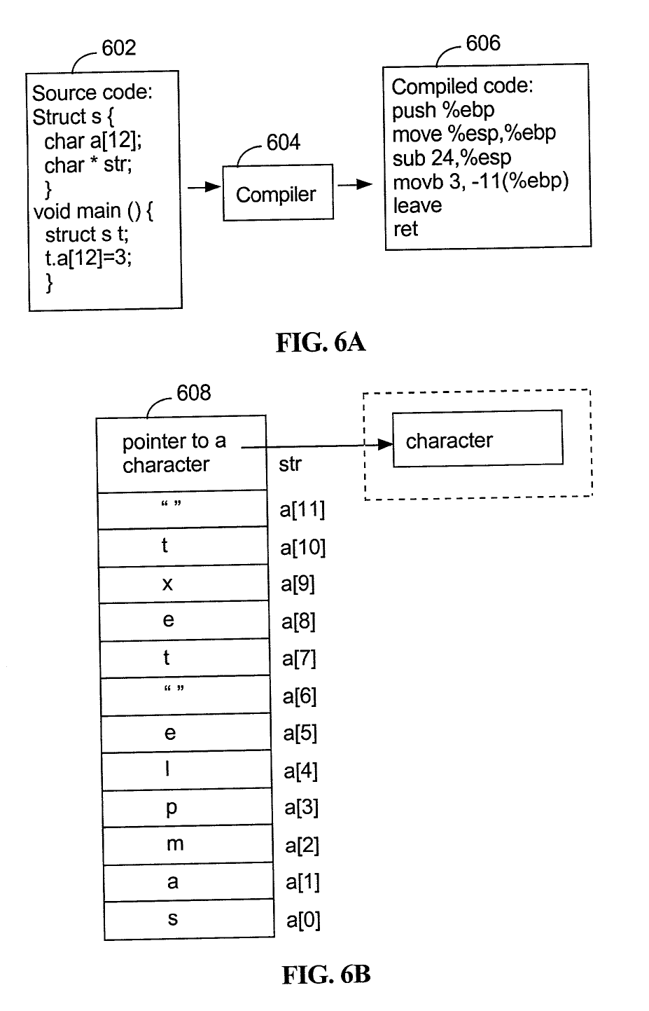

For purposes of illustration, one example of the operation of the present invention will now be described. Turning to FIG. 6A, a small segment of source code 602 is shown (written in the C programming language), having two principal instructions: (1) struct s {char a[12]; char*str} and (2) void main ( ) {struct s t; t.a[12]=3;}. The first instruction establishes a record called “struct s,” which has an array twelve elements long (“a[12]”) of data type “character” (“char”), and includes a pointer (“str”) to a “character.” In C nomenclature, the array elements are a[0] through a[11]. The next element in memory (as defined by the “struct” statement), beginning at an offset of 12 from a[0], is the pointer “str.” (While “str” may be a single byte address, in practice it is more likely to be a four-byte memory address.) The second instruction constitutes the procedure “main,” consisting of two sub-instructions, the first of which declares a variable “t” of type “struct s,” and the second of which attempts to write the value 3 into the “.a[12]” field of the “t” record. An example of “t” is shown in FIG. 6B as array 608.

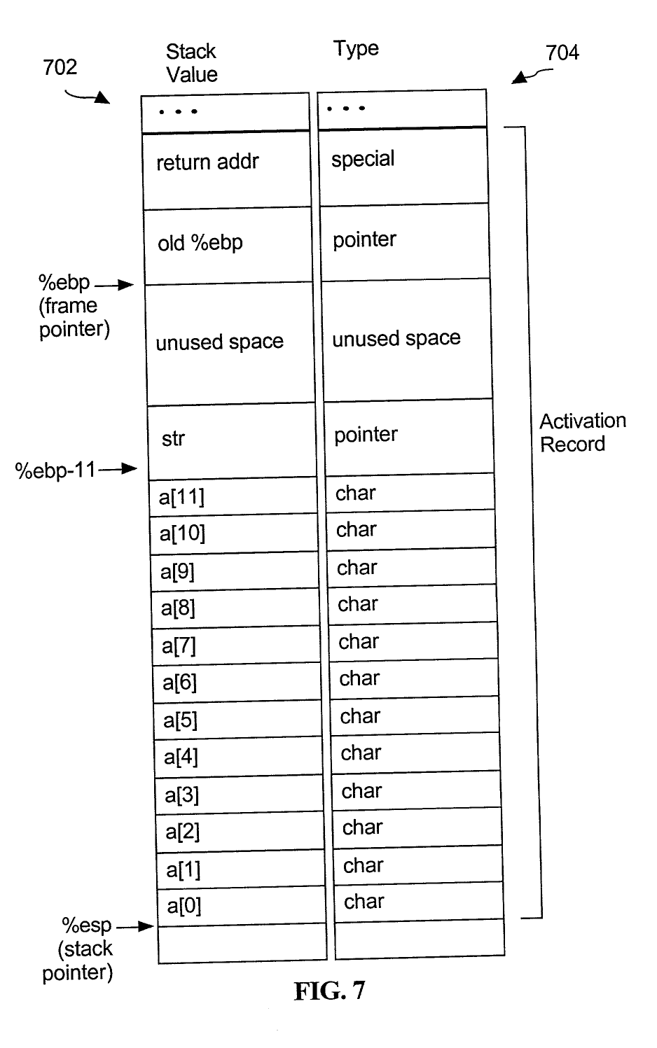

In FIG. 6A, the source code is compiled by compiler 604 to produce compiled code 606. Compiled code 606 is, for purposes of this illustration, assembly code. As discussed above, the functionality of the present invention can be implemented using an interpreter (as in the example of FIG. 6), or can be implemented using instrumented dynamic checking instructions. The effect of the compiled code 606 on memory is shown in FIG. 7. FIG. 7 shows two separate but corresponding portions of memory: stack 702 and stack shadow array 704. Stack 702 grows downward, or from higher to lower addresses, by decrementing a stack pointer. The stack pointer keeps track of the current “top” of the stack.

Right after (or in some cases before) the procedure “main” of source code 602 is called, the return address of the procedure or program that calls “main” is stored on the stack. The return address is shown in FIG. 7 as the “return addr” stack value stored on the stack at the topmost location. Also, the interpreter identifies a location in the stack shadow array 704 that corresponds to the location on the stack of the stored “return addr” value, and assigns it a data type of“special.” This data type indicates that the value on the stack at the corresponding stack location has a special purpose, and is not available for general use.

It is possible that a data type already exists at the location in the stack shadow array 704 corresponding to the location on the stack of the stored “return addr” value, if the location has been used previously. If so, then in one embodiment, the program interpreter first compares the existing data type at this location with the data type current being written into the shadow array (“special”). If the data types are different, the interpreter generates a report of the error. The interpreter then overwrites the old data type with the “special” data type corresponding to the return address stored on the stack. In this particular instance, the data-type inconsistency between an existing data type in the stack shadow array, and the new data type of the return address, is not significant, because the corresponding location on the stack is being newly allocated at the time the return address is pushed onto the stack. In this context, and in accordance with one embodiment of the present invention (as discussed previously), no data type comparisons are made during establishment of an activation record. Alternatively, if a comparison is made and an inconsistency determined, no report of an error is generated. In other contexts, however, a data-type inconsistency with respect to data on the stack could be very significant, and a report of the error would be generated.

Referring to the compiled code 606 in FIG. 6, the first instruction (“push”) pushes the current location of the frame pointer (“% ebp”) onto the stack, shown in FIG. 7 as “old % ebp.” This ensures that the location of the frame pointer can be retrieved after execution of “main.” Correspondingly, the interpreter writes a data type of “pointer” into the corresponding location of the stack shadow array 704 and, in one embodiment, makes a data-type consistency check. Next, the second instruction of the compiled code (“move”) stores the address of the stack pointer (“% esp”) in the location for the frame pointer (“% ebp”), causing the frame pointer to now point to the top of the stack. The values for the stack and frame pointer are typically stored in registers. Thus, the interpreter, in one embodiment, would make a data-type comparison between the data type of the register where the frame pointer is located (“pointer”), and the data type of the value being moved into that register (“pointer”), determining that they are consistent. In another embodiment, as discussed previously, the interpreter does not make data-type comparisons related to creation of the initialization record on the stack.

At this point in the execution of the program, the top of the stack is represented by the “% ebp (frame pointer)” pointer in FIG. 7 (the “% esp (stack pointer)” would also point to the top of the stack at this time). Next, the third instruction of the compiled code (“sub”) allocates space for the local variables on the stack by decrementing the stack pointer twenty-four (24) bytes down the stack. This decrement of the stack pointer by twenty-four (24) bytes is shown in FIG. 7 by the location of the “% esp (stack pointer)” pointer, which is twenty-four (24) bytes down from the “% ebp (frame pointer).” This completes the initialization of the activation record for the function “main,” which extends from the first value pushed on the stack during execution of the function (the return address of the calling function), to the stack pointer after allocation of the space for the local variables.

Next, the interpreter actually allocates the memory for the local variable “t,” and stores data type values in the corresponding entries (i.e., locations) of the shadow array. This functionality is not shown as explicit assembly code, but rather is handled by the interpreter. As shown in FIG. 7, the only local variable is variable “t” of type “struct s,” shown in FIG. 7 as the array elements a[0] through a[11], plus the pointer “str.” The interpreter can derive the data types of “t” from the debug information, and specifically from the initialization record information for functions and procedures 318, and/or from the type declarations for structures 314. It then writes these data types into the stack shadow array at the locations corresponding to the locations in memory that have been allocated for “t,” including twelve array elements of type “char,” and one variable of type “pointer.”

Next, the compiled code moves a byte (“movb”)—the value “3”—into memory at a location decremented 11 bytes from the frame pointer. This specific location is shown in FIG. 7 as the “% ebp-11” pointer. This location is eleven (11) bytes down from the frame pointer, and therefore thirteen (13) bytes up from the stack pointer, because the stack pointer is twenty-four (24) bytes down from the frame pointer. Further, this location is twelve (12) spaces offset from a[0], and thus directly located in the “str” pointer portion of the local variable “t” on the stack.

In accordance with one embodiment of the present invention, before the value “3” is actually written into this memory location, the interpreter checks the corresponding location of the stack shadow array 704 for data-type consistency. In another embodiment, the interpreter would execute the instruction first, overwriting the byte at the location eleven bytes down from the frame pointer, before checking for data-type consistency. Regardless of when it does its shadow array check, the interpreter would find that the data type at the location 11 bytes down from the frame pointer is data type “pointer.” In contrast, the data type of the value to be written into memory—“3”—is an integer (“int”), and the interpreter thus reports that there is an inconsistency between these data types. If it has not already done so, the interpreter will then execute the instruction and overwrite the byte at the location eleven bytes down from the frame pointer. However, in one embodiment of the invention, the interpreter sends an interrupt signal that causes the user to be notified of the error and queried as to how to proceed.

As discussed above, the fact that the value “3” of type “int” is erroneously written to an area of memory reserved for local variable “t” does not automatically convert this portion of memory over to data type “int.” Rather, in one embodiment, it remains a “pointer”-typed portion of memory, such that if another instruction attempts to write a non-“pointer” value into this location (such as another integer), the interpreter would still report out a data-type inconsistency error, despite the fact that an integer currently resides at that location. This ensures continuous error reporting for ongoing data-type inconsistencies interfering with memory integrity. In other embodiments, the “int” data type of the value “3” would overwrite the “pointer” data type at the corresponding location in the stack shadow array.

The final instructions of the compiled code (“leave,” “ret”) cause the procedure “main” to be exited, returning control to the program that called “main.” While this procedure is merely an illustrative example of one way the present invention may be utilized in practice, it demonstrates the benefits of dynamic data-type checking. A mere inspection of the allocation bits associated with the pointer “str” (not shown) would not have detected the “out of bounds”-type memory error illustrated in the example, because the procedure main was attempting to write the byte “3” into a portion of the stack 702 that had already been allocated. However, a data-type comparison does reveal the error, as demonstrated. Also, because program instructions in C are not data-typed, it would be difficult to detect this data-type inconsistency using a static data-type checker. If in the exemplary procedure of FIG. 7 the index into the array a[ ] were a variable, instead of the constant “12”, checking for the data-type inconsistency would be even more difficult, if not impossible, using a static data-type checker. Further, even if the instructions of a program are data-typed, data-type inconsistencies involving memory locations that dynamically change data type during the program are particularly difficult to determine during a static analysis of the program.

In one embodiment of the present invention, the shadow arrays may indicate more than one data type at each location. This may occur where a particular type of data falls within the intersection or union of different data types. If this occurs, in one embodiment, the data-type checker checks the data type of the instruction against each of the multiple data types of the memory location to see if there is a single consistency. Similarly, if an instruction correlates to more than one data type, then each data type of the instruction is checked against the data type of the corresponding memory location to see if any of the data types of the instruction are consistent with the data type of the memory location. In some cases, the data types of memory locations and the data types of instructions can be consistent even if they are not identical—for example, data types of the same class can be consistent in one embodiment of the present invention.

The present invention can be also implemented as a computer program product that includes a computer program mechanism embedded in a computer readable storage medium. For instance, the computer program product could contain one or more of the program modules and data structures shown in FIGS. 1A and 1B. These modules maybe stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A method of dynamically verifying program operation, comprising:
executing a specified computer program;
while executing the specified computer program, maintaining a shadow array, the shadow array having entries corresponding to respective memory locations used by the specified computer program, each entry of the shadow array indicating a data type of the corresponding respective memory location;
the execution of the specified computer program including executing each of a plurality of instructions of the computer program, wherein execution of each instruction of a subset of the plurality of instructions includes:
determining whether execution of the instruction is inconsistent with an entry of the shadow array and generating a report when execution of the instruction is determined to be inconsistent with the entry of the shadow array;
executing the instruction; and
updating the shadow array in accordance with execution of the instruction.

2. The method of claim 1 wherein the execution of each instruction in the subset of the plurality of instructions includes:
identifying a memory location to be accessed by the instruction;
inspecting the shadow array entry corresponding to the identified memory location; and
determining whether execution of the instruction is inconsistent with the inspected shadow array entry.

3. The method of claim 2 wherein access of the memory location by the instruction comprises a read operation.

4. The method of claim 2 wherein access of the memory location by the instruction comprises a write operation.

5. The method of claim 1 wherein the determining includes determining whether proper execution of the instruction requires accessing data of a predefined data type that is different from the data type specified by the entry of the shadow array.

6. The method of claim 1 wherein the determining includes determining whether proper execution of the instruction is inconsistent with the data type specified by the entry of the shadow array.

7. The method of claim 1 wherein the respective memory locations include CPU registers, stack locations, and memory heap locations.

8. The method of claim 1 wherein the data type indicated by at least a subset of the shadow array entries indicates whether the corresponding memory location has been allocated.

9. The method of claim 1 wherein the data type indicated by at least a subset of the shadow array entries indicates whether the corresponding memory location has been initialized.

10. The method of claim 1, further comprising:
compiling a source code program into the specified computer program;
obtaining debugging information related to the specified computer program; and
initializing the shadow memory based on the debugging information.

11. The method of claim 1, further comprising not executing the instruction when execution of the instruction is determined to be inconsistent with the entry of the shadow array.

12. A computer program product for use in conjunction with a computer system, the computer program product comprising a computer readable storage medium and a computer program mechanism embedded therein, the computer program mechanism comprising:
a specified computer program;
a shadow array module for maintaining a shadow array, the shadow array having entries corresponding to respective memory locations used by the specified computer program, each entry of the shadow array indicating a data type of the corresponding respective memory location; and
an interpreter module for executing the specified computer program including executing each of a plurality of instructions of the specified computer program, wherein execution of each instruction of a subset of the plurality of instructions includes:
determining whether execution of the instruction is inconsistent with an entry of the shadow array and generating a report when execution of the instruction is determined to be inconsistent with the entry of the shadow array;
executing the instruction; and
updating the shadow array in accordance with execution of the instruction.

13. The computer program product of claim 12 wherein the execution of each instruction in the subset of the plurality of instructions includes:
identifying a memory location to be accessed by the instruction;
inspecting the shadow array entry corresponding to the identified memory location; and
determining whether execution of the instruction is inconsistent with the inspected shadow array entry.

14. The computer program product of claim 13 wherein access of the memory location by the instruction comprises a read operation.

15. The computer program product of claim 13 wherein access of the memory location by the instruction comprises a write operation.

16. The computer program product of claim 12 wherein the determining includes determining whether proper execution of the instruction requires accessing data of a predefined data type that is different from the data type specified by the entry of the shadow array.

17. The computer program product of claim 12 wherein the determining includes determining whether proper execution of the instruction is inconsistent with the data type specified by the entry of the shadow array.

18. The computer program product of claim 12 wherein the respective memory locations include CPU registers, stack locations, and memory heap locations.

19. The computer program product of claim 12 wherein the data type indicated by at least a subset of the shadow array entries indicates whether the corresponding memory location has been allocated.

20. The computer program product of claim 12 wherein the data type indicated by at least a subset of the shadow array entries indicates whether the corresponding memory location has been initialized.

21. The computer program product of claim 12, further comprising a compiling and debugging module for compiling a source code program into the specified computer program, and wherein the shadow array module further:
obtains debugging information related to the specified computer program from the compiling and debugging module; and
initializes the shadow memory based on the debugging information.

22. The computer program product of claim 12, further comprising not executing the instruction when execution of the instruction is determined to be inconsistent with the entry of the shadow array.

23. A computer program product for use in conjunction with a computer system, the computer program product comprising a computer readable storage medium and a computer program mechanism embedded therein, the computer program mechanism comprising:
a program instrumenting module for adding dynamic checking instructions to a compiled program to generate an instrumented program, the dynamic checking instructions including instructions for establishing a shadow array, the shadow array having entries corresponding to respective memory locations used by the compiled program, each entry of the shadow array indicating a data type of the corresponding respective memory location;
the compiled program including a plurality of instructions;
wherein the dynamic checking instructions are configured so that during execution of instructions of the instrumented program, for each instruction of a subset of the plurality of instructions of the compiled program, the dynamic checking instructions:
determine whether execution of the instruction of the compiled program is inconsistent with an entry of the shadow array and generate a report when execution of the instruction is determined to be inconsistent with the entry of the shadow array; and
update the shadow array in accordance with execution of the instruction of the compiled program.

24. The computer program product of claim 23 wherein the determining comprises:
identifying a memory location to be accessed by the instruction;
inspecting the shadow array entry corresponding to the identified memory location; and
determining whether execution of the instruction is inconsistent with the inspected shadow array entry.

25. The computer program product of claim 24 wherein access of the memory location by the instruction comprises a read operation.

26. The computer program product of claim 24 wherein access of the memory location by the instruction comprises a write operation.

27. The computer program product of claim 23 wherein the determining includes determining whether proper execution of the instruction requires accessing data of a predefined data type that is different from the data type specified by the entry of the shadow array.

28. The computer program product of claim 23 wherein the determining includes determining whether proper execution of the instruction is inconsistent with the data type specified by the entry of the shadow array.

29. The computer program product of claim 23 wherein the respective memory locations include CPU registers, stack locations, and memory heap locations.

30. The computer program product of claim 23 wherein the data type indicated by at least a subset of the shadow array entries indicates whether the corresponding memory location has been allocated.

31. The computer program product of claim 23 wherein the data type indicated by at least a subset of the shadow array entries indicates whether the corresponding memory location has been initialized.

32. The computer program product of claim 23, further comprising a compiling and debugging module for compiling a source code program into the compiled program, and wherein the dynamic checking instructions further:
obtain debugging information related to the compiled program from the compiling and debugging module, and
initialize the shadow memory based on the debugging information.

33. The computer program product of claim 23, further comprising not executing the instruction when execution of the instruction is determined to be inconsistent with the entry of the shadow array.
